(19) United States
(12) Patent Application Publication
(10) Pub. No.: US 2026/0099922 A1
(43) Pub. Date: Apr. 9, 2026

(54) AGRICULTURE IMAGE ANALYSIS METHODS AND SYSTEMS

(71) Applicant: NUtech Ventures, Lincoln, NE (US)

(72) Inventors: Geng (Frank) Bai, Lincoln, NE (US); Nipuna Chamara, Lincoln, NE (US); Yufeng Ge, Lincoln, NE (US)

(21) Appl. No.: 19/352,719

(22) Filed: Oct. 8, 2025

Related U.S. Application Data
(60) Provisional application No. 63/704,762, filed on Oct. 8, 2024.

(51) Int. Cl. G06T 7/00; G06T 7/11; G06V 10/26; G06V 10/82; G06V 10/98; G06V 20/10; G06V 40/10

(52) U.S. Cl. CPC G06T 7/0012; G06T 7/11; G06V 10/26; G06V 10/82; G06V 10/993; G06V 20/188; G06V 40/10; G06T 2207/20081; G06T 2207/20084; G06T 2207/30188; G06T 2207/30242

(57) ABSTRACT

An agriculture image analysis method includes acquiring crop canopy image data. Multiple agricultural features are extracted from edge processing of the image data and conducting data reduction to produce a real-time transmissible data set using an automated phenocam that uses a trained multiclass DCNN network. The real-time transmissible data is provided to a cloud based resource. An automated phenocam includes imaging and crop sensors, a local power source, and a single processor board that implements a trained multiclass DCNN network to produce a real-time transmissible data set regarding crop status.

### PRIORITY CLAIM AND REFERENCE TO RELATED APPLICATION

The application claims priority under 35 U.S.C. § 119 from prior U.S. provisional application Ser. No. 63/704,762, which was filed Oct. 8, 2024. All applications mentioned in this paragraph are incorporated by reference.

### FEDERALLY SPONSORED RESEARCH AND DEVELOPMENT

This invention was made with government support under grant number 2020-68013-32371 awarded by the United States Department of Agriculture. The government has certain rights in this invention.

### FIELD

A field of the invention is agricultural image analysis.

### BACKGROUND

Phenology is the study of the cyclic events of living organisms. Plant phenology can provide information useful to agricultural management. A phenocam is a camera that continously target on plant part, a whole plant, or a crop canopy and commonly used to track plant phenological characteristics. A typical phenocam includes only an RGB image sensor.

Conventional phenocam systems store images locally. Post-image processing is conducted to analyze the images. See, e.g., Aasen, H., Kirchgessner, N., Walter, A., & Liebisch, F “PhenoCams for Field Phenotyping: Using Very High Temporal Resolution Digital Repeated Photography to Investigate Interactions of Growth, Phenology, and Harvest Traits,” Frontiers in Plant Science, 11 June 202, 1-16. https://doi.org/10.3389/fpls.2020.00593. Phenocams are often set up in remote locations that have limited accessibility to power and internet connectivity, which limits real-time decision-making capability and can prevent remote access to data of the remote site data.

Post-processing of phenocam images has been used for leaf area index estimation (supra), growth rate estimation (Sakamoto, T., Gitelson, A. A., Nguy-Robertson, A. L., Arkebauer, T. J., Wardlow, B. D., Suyker, A. E., Verma, S. B., & Shibayama, M. (2012). An alternative method using digital cameras for continuous monitoring of crop status. Agricultural and Forest Meteorology, 154-155, 113. https://doi.org/10.1016/j.agrformet.2011.10.014), leaf chlorophyll content, leaf nitrogen concentration estimation, and fruit content (Wang, Y., Wang, D., Shi, P., & Omasa, K. (2014). Estimating rice chlorophyll content and leaf nitrogen concentration with a digital still color camera under natural light. Plant Methods, 10(3), 273-286. https://doi.org/10.1016/S0378-4290(99) 00063-5), fruit count (Y. Wang et al., 2014), and plant height estimation (Sritarapipat, T., Rakwatin, P., & Kasetkasem, T. (2014). Automatic rice crop height measurement using a field server and digital image processing. Sensors (Switzerland), 14(1), 900-926. https://doi.org/10.3390/s140100900).

Further post-image processing lets the estimation of biotic stress such as pest density estimation (Barbedo, J. G. A. (2014). Using digital image processing for counting whiteflies on soybean leaves. Journal of Asia-Pacific Entomology, 17(4), 685-694. https://doi.org/10.1016/j.aspen.2014.06.014), weed estimation (Wang, A., Zhang, W., & Wei, X. (2019). A review on weed detection using ground-based machine vision and image processing techniques. Computers and Electronics in Agriculture, 158 (January), 226-240. https://doi.org/10.1016/j.compag.2019.02.005), and abiotic stress such as nutrient deficiency (Ghorai, A. K., Barman, A. R., Chandra, B., Viswavidyalaya, K., Jash, S., Chandra, B., Viswavidyalaya, K., Chandra, B., & Viswavidyalaya, K. (2021). Image Processing Based Detection of Diseases and Nutrient Deficiencies in Plants. SATSA Mukhapatra, 25(1), 1-24).

Image processing techniques can be categorized into two domains as standard and deep learning-based approaches. Standard approaches conduct image feature extraction by shape features, texture features, and color features (Anubha, P. S., Sathiesh Kumar, V., & Harini, S. (2019). A study on plant recognition using conventional image processing and deep learning approaches. Journal of Intelligent and Fuzzy Systems, 36(3), 1997-2004. https://doi.org/10.3233/JIFS-169911). The deep learning-based approach uses convolutional neural networks (CNN) to extract features from images (Luis′, S., Filipe, N. S., Paulo, M. O., & Pranjali, S. (2020). Deep Learning applications in agriculture: a short review. Deep Learning Applications in Agriculture: A Short Review, 1092 AISC (January), C1. https://doi.org/10.1007/978-3-030-35990-4). When the number of CNN layers is more than 30 the CNN structure is named a deep convolutional neural network (DCNN).

Generally, DCNN models are heavy due to the large number of parameters these models hold. Therefore, it is difficult to implement these models practically in embedded systems that have less computation power, like agricultural monitoring and management systems.

Edge image processing can reduce the high throughput data transmission over a wireless IoT-enabled imaging network (Cao, K., Liu, Y., Meng, G., & Sun, Q. (2020). An Overview on Edge Computing Research. IEEE Access, 8, 85714-85728. https://doi.org/10.1109/ACCESS.2020.2991734). Potted flowers were identified with precision above 89% in real-time in a Jetson TX 2 computing module based on a DCNN algorithm (Wang, J., Gao, Z., Zhang, Y., Zhou, J., Wu, J., & Li, P. (2022). Real-time detection and location of potted flowers based on a ZED camera and a YOLO V4-tiny deep learning algorithm. Horticulturae, 8(1). https://doi.org/10.3390/horticulturae8010021), and for weed detection (Wang, Q., Cheng, M., Huang, S., Cai, Z., Zhang, J., & Yuan, H. (2022). A deep learning approach incorporating YOLO v5 and attention mechanisms for field real-time detection of the invasive weed Solanum rostratum Dunal seedlings. Computers and Electronics in Agriculture, 199 (July), 107194. https://doi.org/10.1016/j.compag.2022.107194). Real-time weed detection with a precision above 90% was described, but this required expensive hardware that is unsuitable for many agricultural applications. Wang's workflow involves batch processing of imagery using object detectors. This implies collecting images, transferring them to a computing environment (e.g. server or workstation), running detection models, merging detections, etc. This is a post-processing pipeline that is not a real-time embedded solution. Wang also uses a complex model. Deep learning detectors like YOLOv5 demand non-trivial compute (GPU acceleration, memory) for inference, especially with high-resolution sub-images. While it's possible to optimize or simplify models, Wang describes no soluation of highly constrained hardware (e.g. microcontrollers, low-power edge devices). Wang provides no soluation for implementations that have significant design constraints, e.g., limited power, offline operation without connectivity, or remote in-field to can be collected and processed under favorable computational conditions with access to powerful computational resources.

### SUMMARY

A preferred agriculture image analysis method includes acquiring crop canopy image data. Multiple agricultural features are extracted from edge processing of the image data and conducting data reduction to produce a real-time transmissible data set using an automated phenocam that uses a trained multiclass DCNN network. The real-time transmissible data is provided to a cloud based resource.

A preferred automated phenocam includes imaging and crop sensors, a local power source, and a single processor board that implements a trained multiclass DCNN network to produce a real-time transmissible data set regarding crop status.

### BRIEF DESCRIPTION OF THE DRAWINGS

FIG. 1A is a schematic diagram of preferred agriculture image analysis system in an agricultural field.

FIG. 1B shows steps for edge imaging processing conducted in the system of FIG. 1A.

FIG. 1C provides a flow chart of preferred edge processing.

FIG. 2 shows steps used to select model architecture/model backbone weights and

image input sizes to train models used in the system of FIG. 1A.

FIG. 3 shows the hardware of overview of AlCropCAM used in an experimental version of the system of FIG. 1A and its data flow.

FIG. 4 shows a flow chart of a preferred sequential image processing and data generation.

FIG. 5 is a flowchart of transmission message generation and data size reduction visualization from the experimental version of the system of FIG. 1A

FIG. 6 shows a Confusion matrix for test images from the experimental version of the system of FIG. 1A.

FIGS. 7A and 7B respectively show an example of an original soybean image and the segmentation result from the experimental version of the system of FIG. 1A.

FIG. 8 shows diurnal and seasonal curves generated by the experimental version of the system of FIG. 1A.

### DETAILED DESCRIPTION OF THE PREFERRED EMBODIMENTS

A preferred provides a device for quantitatively measuring different plant and crop parameters than performed by traditional scaler or vector sensors for precision agriculture. A camera with an embedded processor performs edge image processing and transmit the results to a cloud IoT platform as telemetry data. Whole images are not sent, and the device only transmits the user data the user needs.

Preferred embodiments can 1. Use edge image processing with multiple image processing algorithms. 2. Integrate data transmission to the system to reduce transmission cost and address the issues of non-availability of reliable transmission 3. Operate in field commercial crop monitoring 4. Use image processing algorithms to identify corn, soybean, plant types, canopy coverage, and identify weeds in the early stages of the crop. Also, plant features such as tassels and leaves can be identified.

Preferred embodiments enable field phenocams with poor internet connectivity to acquire real-time decision-making based on real-time image processing. A phenocam system of the invention extracts plant level and crop canopy level parameters through DCNN and uploads to the cloud via low power low throughput communication protocols. Preferred systems use close canopy cameras set up 0.5-2 m above the canopy on stationery nodes, while other typical image sources can be used.

Preferred embodiments of the invention will now be discussed with respect to experiments and drawings. Broader aspects of the invention will be understood by artisans in view of the general knowledge in the art and the description of the experiments that follows.

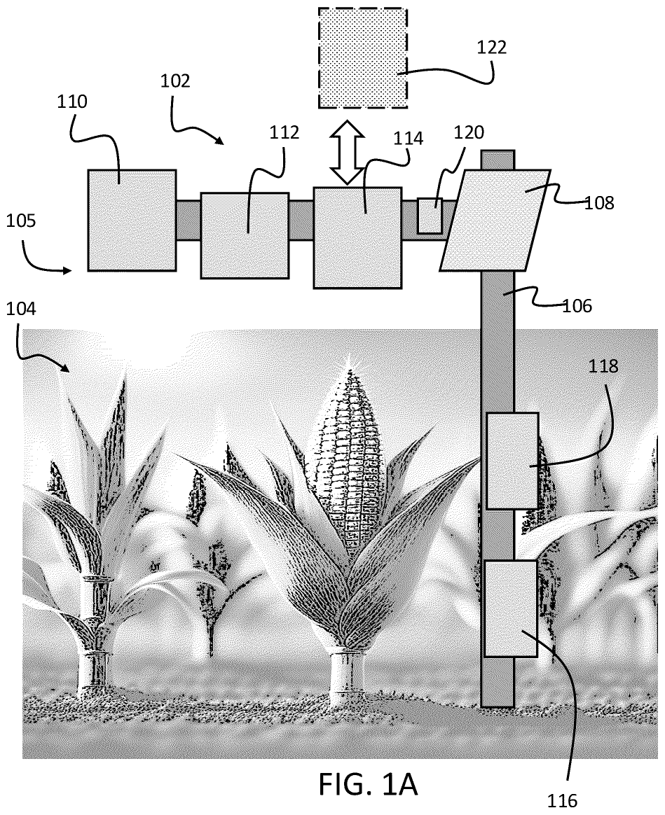

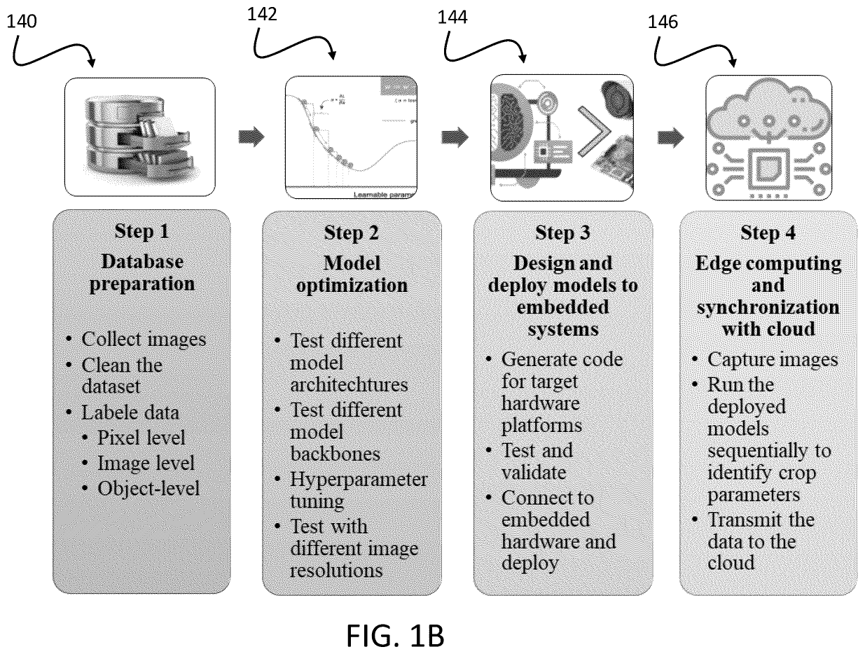

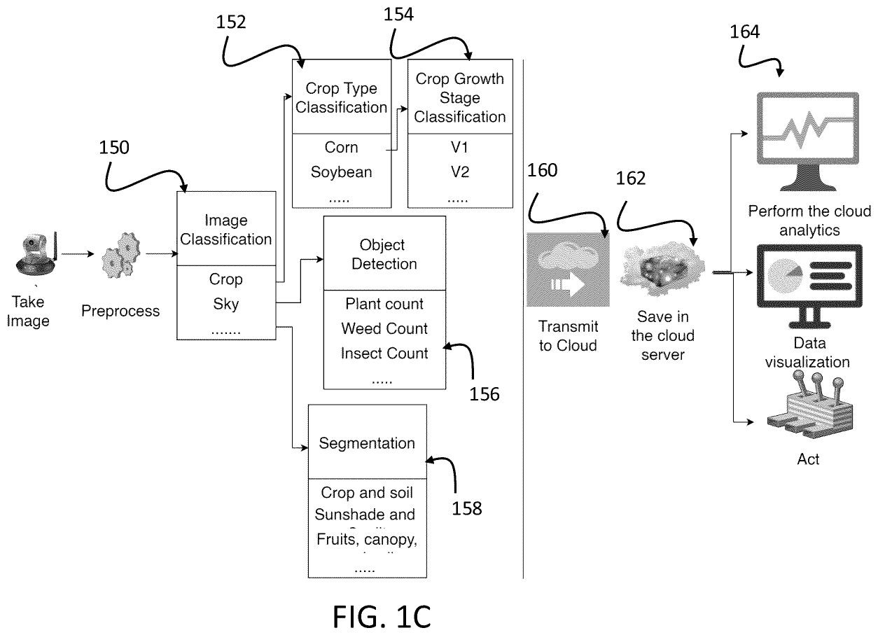

FIG. 1A shows a preferred agriculture image analysis system 102 in an agricultural field 104. A components cluster 105 is mounted on one or more supports 106, preferably in close proximity to a crop in the field 104. Imaging and other soil and field and crop sensors are mounted and can be powered by a solar panel module 108. Imaging components 110 can include an Infrared radiometer, NDVI (normalized difference vegetation index) and PRI (photochemical reflectance index) sensors, a trail camera, and an imaging and multispectral sensing platform. This includes/integrates a multispectral sensor to calculate vegetation indices that can be used for crop stress calculations, e.g., water stress and nitrate stress. A trail camera, also known as a game camera, is a rugged, battery-powered digital camera used for observing wildlife or monitoring security, typically placed in the wilderness and triggered by motion to capture photos or videos of animals. Such sensors can be included as a sensor node 112 for plant monitoring. A communication module 114 includes RF components and antennas for communications. Each cluster/support can include its own communication module, or a plurality of clusters/supports can share communications through a single communication module for the plurality. A soil moisture sensing data logger 116 and an infrared radiometer data logger 118 are also included. A computer module 120 provides processing and storage. The system 102 of FIG. 1A provides an automated Phenocam that uses AI models to extract data.

Each component cluster/support provides a field-deployable imaging framework that integrated edge image processing, Internet of Things (IoT), and has access to a LoRaWAN (through its own or another communication module) for low-power, long-range communications. The communications module 114 access a trained multiclass DCNN network 122.

Testing was conducted of a system consistent with the system of FIG. 1A. The field-deployable imaging framework that integrated edge image processing (in module 120), Internet of Things (IoT) (sensors), and LoRaWAN (communication module 114 (for low-power, long-range communication. The DCCN network component 122 referred to as AlCropCAM (is a stack of four Deep Convolutional Neural Networks (DCNN) running sequentially: CropClassiNet for crop type classification, CanopySegNet for canopy cover quantification, PlantCountNet for plant and weed counting, and InsectNet for insect identification. These DCNN models were trained and tested with >43,000 field crop images collected offline. AICropCAM was embodied on a distributed wireless sensor network with its sensor node consisting of an RGB camera for image acquisition, a Raspberry Pi 4B single-board computer for edge image processing, and an Arduino MKR1310 for LoRa communication and power management.

Our testing showed that the time to run the DCNN models ranged from 0.58 s for CropClassiNet to 15.62 s for CanopySegNet, and power consumption ranged from 4.1 W for InsectNet to 5.78 W for CanopySegNet. The classification model CropClassiNet reported 94.5% accuracy, and the segmentation model CanopySegNet reported 92.83% accuracy. The two object detection models PlantCountNet and InsectNet reported mean average precision of 0.69 and 0.02 for the test images. Predictions from the DCNN models were transmitted to the ThingSpeak IoT platform for visualization and analytics. We concluded that AlCropCAM successfully implemented image processing on the edge, drastically reduced the amount of data being transmitted, and could satisfy the real-time need for decision-making in PA. AlCropCAM can be deployed on moving platforms such as center pivots or drones to increase its spatial coverage and resolution to support crop monitoring and field operations.

AlCropCAM can perform edge image processing and low-throughput, low-power, and long-range data transmission through IoT technology. In this novel AlCropCAM platform, multiple DCNN image processing algorithms run in series to extract plant-level and canopy-level features in an embedded system. Image classification, object detection with classification, and image segmentation are the three major applications of DCNN image processing, and all three are included in AICropCAM to demonstrate the capabilities of DCNN for image processing in PA. AlCropCAM has trained models for canopy segmentation, crop classification, plant growth stage identification, plant counting, weed counting, and plant type identification. All the protocols that transmit data from AlCropCAM to the Cloud were custom designed. AlCropCAM sends the generated data to a cloud platform for logging, visualization, and analysis.

FIG. 1B shows the steps for edge image processing program deployment in the DCNN distributed network 122. In a first step 140, the data base is prepared by collecting images, cleaning the data and labelling data at the pixel, image, and object level. In a second step 142, model optimization is conducted. Different model architectures and backbones are tested, hyper parameter tuning is conducted, and testing is conducted at a plurality of image resolutions. In a third step 144, models are designed and deployed to the DCNN distributed network 122. Code is generated for targeted hardware platforms and connected and deployed to the hardware in the system. In a fourth step 146, edge computing and cloud synchronization is conducted. Deployed models are run sequentially to identify crop parameters, and then the information is transmitted to the cloud.

FIG. 1C provides a flow chart of preferred edge processing. An image is taken and preprocessed, e.g., image resizing. The images are first classified 150 as crop or sky. Crop type classification 152 is followed by crop growth stage classification 154. Object detection 156 distinguishes between plant, weeds, and insects. Segmentation 158 distinguishes between crop canopy and soil, sunlit and sunshade. Reduced information is then transmitted 160 via wireless communication protocols and stored 162 in a cloud server. From the server, analytics, data visualization can be conducted 164. The Act portion can provide information to a user, e.g. through a message/email about the status of the crop, disease/pest pressure, pest type, number of emerged plants, and plant growth speed.

In experiments, AlCropCAM was implemented on a corn and soybean crop-grown field at the field phenotyping facility in Mead, Nebraska, USA. We demonstrated the training of CropClassiNet for classifying images based on image quality and crop type, CanopySegNet for segmenting crop canopy from the background, PlantCountNet for classifying and counting soybean and weed plants, and finally InsectNet for identifying insects and counting them.

### Image Collection, Annotation, Preprocessing, and Augmentation.

Image collection for DCNN model training occurred in four growing seasons using three different types of cameras: (i) commercially available Meidas SL122 trail cameras, (ii) OV5642 imaging sensors with ArduCAM camera shields, and (iii) Raspberry Pi Camera Module V2 on Raspberry Pi Zero. All the cameras were mounted on horizontally extended bars fixed on vertical stationary poles erected in the field, as shown in FIG. 1A. The distance between the crop canopy and the cameras was maintained between 0.5-1.5 m throughout the growing seasons. Images used for training the InsectNet were captured with smartphones as we could not collect enough images with insects from the three types of cameras above.

Three standard image annotation techniques in deep learning model training were used: (1) folder labeling for image classification, (2) pixel-level annotation for the semantic segmentation model, and (3) bounding boxes for object detection models. Images belonging to the same class were put in a single folder, and five classes (folders) were created: rejected, corn, soybean, grass, and night. Separating the canopy from the soil is possible with semantic segmentation. A bounding box is the smallest rectangle drawn around the object. Table 1 explains each type of annotation used in the model training.

TABLE 1
Annotation criteria used to generate labels from the images to train and test the four deep.

| Labeling Type | Class | Description |
|---|---|---|
| Image | Rejected | Images were labeled as rejected due to multiple reasons: blurred |
| classification | | images caused by water droplets on the lens; the cameras turned |
| (CropClassiNet) | | away from the targeted crop; crops growing up to the camera |
| | | blocking the view or capturing only a few leaves; people present |
| | | in the field; lens covered with different stuff; and the camera was |
| | | not installed in the field. |
| | Corn | Images entirely covered by corn plants at different growth stages |
| | Soybean | Images entirely covered by soybean plants at different growth |
| | | stages |
| | Grass/Weed | The captured images only comprise grass/weed plants at |
| | | different growth stages. |
| | Night | Images captured at nighttime. Most of the cameras were not |
| | | programmed to stop collecting images at night. |
| Crop canopy and | Canopy | Pixel labeling was done on the crop canopy. We used assisted |
| background | | freehand tool and the superpixel option in the MATLAB image |
| (CanopySegNet) | | labeler. |
| | Background | Pixel labeling was done on the crop canopy. We used assisted |
| | | freehand tool and the superpixel option in the MATLAB image |
| | | labeler. |
| Plant-type | Weed | The weed present in the image was labeled using bounding |
| (PlantCountNet) | | boxes. It was challenging to locate the weed after the corn or |
| | | soybean canopy was closed. |
| | Soybean | Soybean plants present in the image were labeled using |
| | | bounding boxes. |
| Insects | Insects | During the labeling process, without distinguishing insects based |
| (InsectNet) | | on their type, all the insects present in the images were labeled |
| | | using bounding boxes. |

Image preprocessing aids DCNN model training and real-time edge image processing. Differences in the input layer size in different DCNN models demand that images be resized before passing through the model for training or prediction purposes. High-resolution images improve accuracy but require more computational power. For specific applications, labeled datasets were only limited available. Therefore, image augmentation techniques were used to increase the number of image data sets, including scaling, flipping, cropping, rotation, color transformation, PCA color augmentation, and noise rejection.

Multiple augmentation techniques were used for each model, as detailed in Table 2. Also provided in Table 2 are the numbers of images in training, validation, and testing for the four DCNN models.

TABLE 2
DCNN model image allocation and image augmentation.

| | Model Parameters | | | | |
|---|---|---|---|---|---|
| Model | Total | Training | Validation | Test | Data Augmentation Techniques |
| CropClassiNet | 43611 | 30528 | 9810 | 3273 | Random rotation, random X and Y |
| | | | | | reflection |
| CanopySegNet | 51 | 31 | 10 | 10 | Transformation (random left/right |
| | | | | | reflection and random X/Y translation |
| | | | | | of +/− 10 pixels) |
| PlantCountNet | 110 | 88 | 11 | 11 | Transformation |
| InsectNet | 542 | 326 | 108 | 108 | Transformation |

The number of images used in training affects the accuracy of prediction. The experiments used a number of images that were expect to train reasonably accurate models.

### DCNN Model Architecture Selection, Training, Evaluation, and Deployment on the Edge Device.

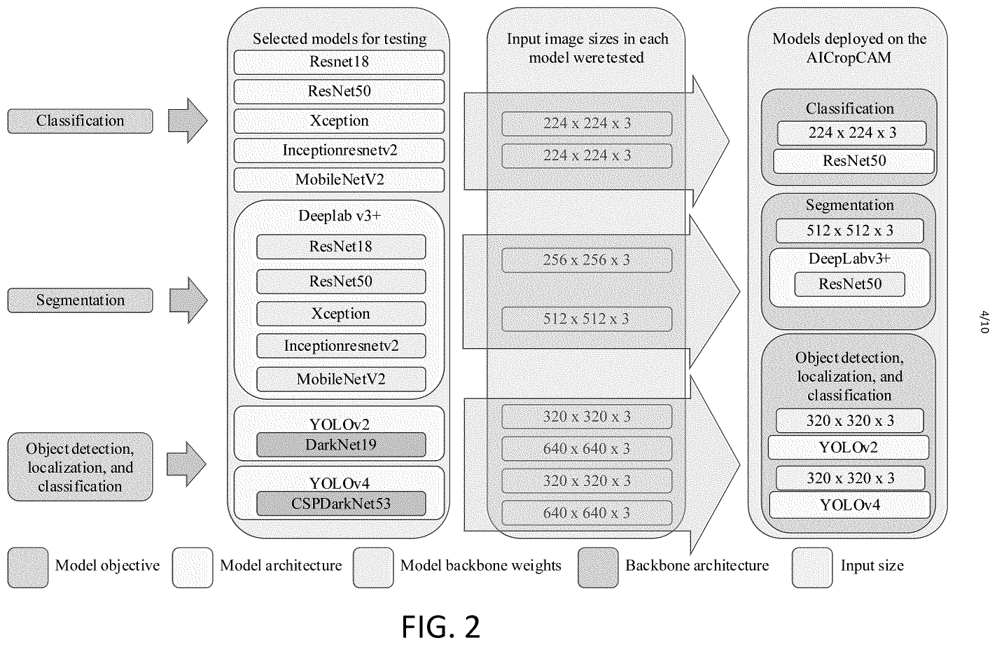

FIG. 2 shows steps used to select model architecture/model backbone weights and image input sizes to train the best model for CropClassiNet, CanopySegNet, PlantCountNet, and InsectNet. Unlike most DCNN applications that pursue higher accuracy, the present goal was a balance between accuracy and model deployability on an edge device. An integrated edge device can include an RGB camera, a single board computer, a power management unit, and a communication module.

For example, in CropSegNet (Segmentation), we selected DeepLabv3+ with weights initialized from pre-trained networks of ResNet18, ResNet50, Xception, InceptionresnetV2, and MobileNetV2. The input image sizes tested were 512×512×3 and 256×256×3, and training options were kept constant to find the best-performing networks, which should also be deployable to Raspberry Pi 4B. This testing identified DeepLabv3+ with ResNet50 as the most suitable model for CropSegNet, with an input image size of 512×512×3. Table 3 summarizes the hyperparameter values and training options for the final DCNN models deployed to the edge.

TABLE 3
Hyperparameter values and training options for all
the best models (SGDM - stochastic gradient.

| Training option | | | Values for | Values for |
|---|---|---|---|---|
| and the function/ | Values for | Values for | InsectNet | PlantCountNet |
| Hyperparameters | CropClassiNet | CanopySegNet | (320 × 320 × 3) | (320 × 320 × 3) |
| Optimizer | SGDM | SGDM | SGDM | RMSProp |
| Momentum | 0.9 | 0.9 | 0.99 | NA |
| Initial learn rate | 0.001 | 0.001 | 0.001 | 0.001 |
| Learn rate schedule | Piecewise | Piecewise | Piecewise | Piecewise |
| Learn rate drop | 10 | 10 | 10 | 10 |
| period | | | | |
| Learn rate drop | 0.3 | 0.3 | 0.1 | 0.3 |
| factor | | | | |
| Minibatch size | 16 | 4 | 16 | 32 |
| L2Regularization | NA | 0.005 | 0.005 | 0.005 |
| Validation | 3 | 3 | 3 | 10 |
| frequency | | | | |
| Shuffle | Every epoch | Every epoch | Every epoch | Every epoch |
| Validation patience | 4 | 10 | 10 | 10 |
| Max epochs | 100 | 300 | 1000 | 100 |
| Execution | Multi GPU | Multi GPU | GPU | GPU |
| environment | | | | |

$$Accuracy = \frac{Number of accurate predictions}{Total images in test dataset} \times 100 \% \qquad Equation 1$$

$$Precision = \frac{True positive}{True positive + False positive} \qquad Equation 2$$

$$Recall = \frac{True positive}{True positive + False positive} \qquad Equation 3$$

$$BF Score ( F 1 Score ) = \frac{2 \times precision \times recall}{( recall + precision )} \qquad Equation 4$$

$$Jaccard index = Absolute \frac{\vert T ⋂ Y \vert}{\vert T ⋃ Y \vert} \qquad Equation 5$$

$$Intersection over union ( IoU ) = \frac{Intersection Area}{Union area} \qquad Equation 6$$

$$Mean Average Precision = \frac{1}{n} {\sum }_{k = 1}^{k = n} {AP}_{k} \qquad Equation 7$$

Model training was performed on an NVIDIA Geforce GTX 1650 Ti Mobile processor, a dedicated mid-range graphics card with 4 GB GDDR6 memory on a Dell XPS 15 9500 Laptop. The laptop had an Intel Core i7-10750H 10th Gen processor and 16 GB DDR4 RAM with 1 TB SSD hard disk.

### Hardware and Software of AICropCAM.

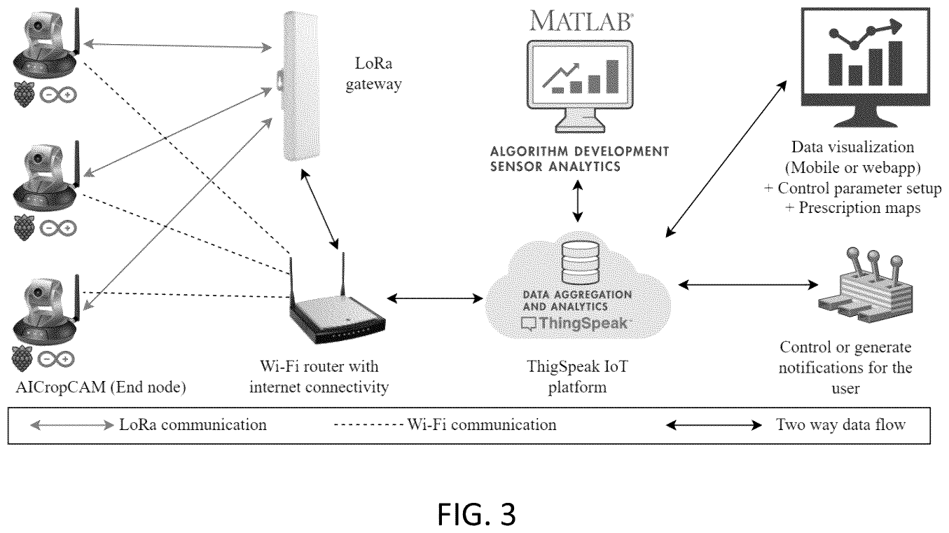

FIG. 3 shows the hardware of overview of AICropCAM and data flow.

The IoT data transmission and edge image processing hardware comprised the following major components: a Raspberry Pi 4B single-board computer, an Arduino MKR1310 development board, an Arduino MKR Relay Proto Shield, and a Dragino OLG02 outdoor dual channels LoRa Gateway. The 12V 8Ah battery powered the Raspberry Pi 4B, controlled through the relay shield managed by the Arduino MKR1310. A 3.7V lithium polymer battery powered the Arduino MKR1310 board. There are two advantages of having a separate Arduino board. First, the Arduino board consumes less power than the Raspberry Pi 4B Pi module. It can be switched on and off according to user requirements. Second, it allows uninterrupted communication between the node and the Cloud with low power.

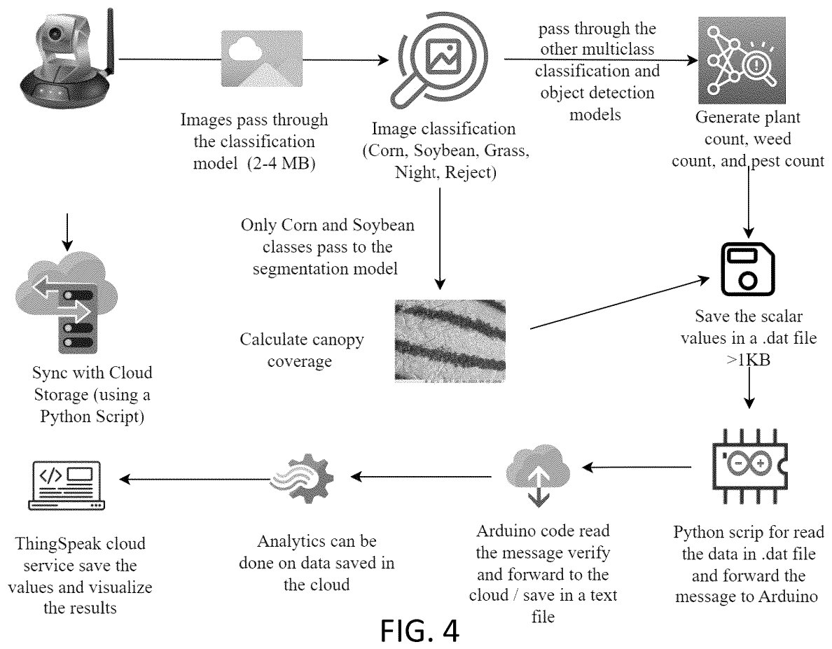

FIG. 4 shows a flow chart of a preferred sequential image processing and data generation.

AlCropCAM required programming on two hardware platforms. Arduino was programmed using C++ in Arduino's Integrated Development Environment. Raspberry Pi imaging and image processing program was developed in MATLAB and deployed onto the Raspberry Pi 4B using the MATLAB Coder and MATLAB Compiler. A python program was designed to read the saved data in the Raspberry Pi 4B and serially communicate to the ARDUINO MKR1310. The primary functions of the MRK1310 program were to (1) turn on the Raspberry Pi module based on the user-defined time intervals, (2) get the processed data, including the results of DCNN model predictions, through serial communication from the Raspberry Pi, and (3) transmit the data to the ThingSpeak Cloud channel through the LoRa gateway. All the DCNN models were trained using the MATLAB deep learning toolbox. In the edge deployment, a MATLAB program runs multiple models logically depending on the prediction result of the previous model estimation. MATLAB coder generates the C and C++ code relevant to the program we developed to run on the Raspberry Pi. MATLAB Compiler generates the standalone application on the Raspberry Pi.

Table 4 explains the abbreviations of the data generated by the models in AlCropCAM. The abbreviations in Table 4 are variables holding data in the program to reduce the complexity of system development and maintain a common standard among different platforms. The image is sized around 2 MB before being fed into the image processing pipeline. The output message contains the crop type (CT), plant count (PC), weed count (WC), canopy coverage (CC), and pest count (PstC). The resulting message is typically less than 100 bytes. The outcome in terms of memory size is around 5/100000 less than the original image, and this message can be transmitted in a single message via LoRa as the maximum LoRa packet size is around 256 bytes.

TABLE 4
List of abbreviations used to represent information in the images.

| Parameter | Abbreviation | Represent information |
|---|---|---|
| Image location | LOC | Node ID manually entered/Global positioning |
| | | system location coordinates |
| Image orientation | IO | Accelerometer/Manually Feed/Gravity Switch |
| Image quality/Crop type | CT | Image classification based on image quality |
| | | and the crop type |
| Plant count/Weed count | PC/WC | Multiclass object detection/classification |
| Crop canopy coverage | CC | Semantic Segmentation |
| Pest count | PstC | Multiclass object detection/classification |

### Data Transmission, Visualization, and Storage

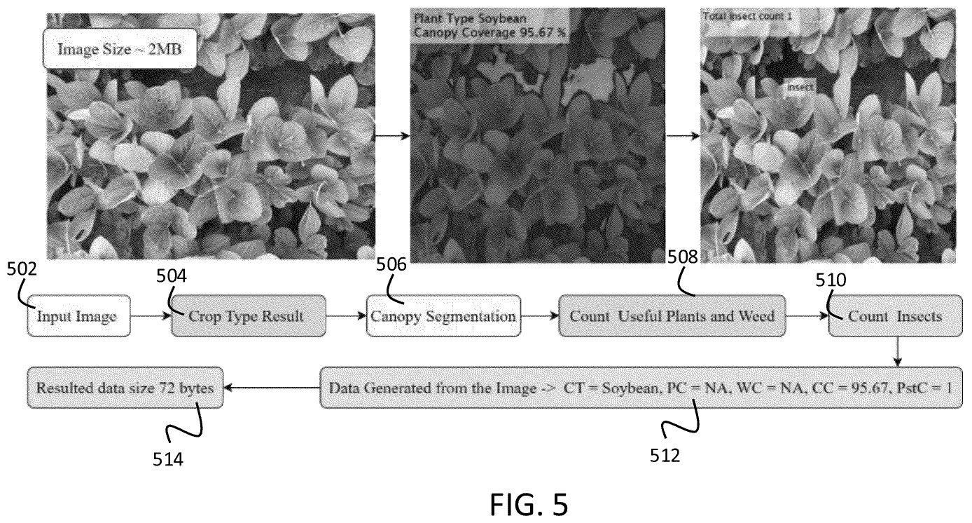

FIG. 5 is a flowchart of transmission message generation and data size reduction visualization. An input image 502, e.g. 2 MB, is identified 504 by the DCNN as a crop type, e.g. soybean. Canopy segmentation 506 is then conducted. Pixels belonging to plant parts are separate from the soil background pixels. Useful plants are separated 508 from soil/background. Insects are counted 510. Reduced data is generated 512 from the image, including data labels such as an image number, timestamp, and location that helps to identify when and where the image was captured. This provides a reduced data set 514, e.g., 72 bytes, that can be transmitted. The reduced data includes information that can be used to make decisions for crop management including to spray pesticides if the pest pressure is high, take replanting decisions if the immerged plant counts are low, adjust fertigation and irrigation needs according to the plant count/density and typically used as a precision crop management data source.

The data generated after image processing were saved on the Raspberry Pi 4B SD card, allowing access to the data anytime, remotely or through manual retrieval through field visits. Two options for transmitting the collected data to the ThingSpeak IoT platform are available. Firstly, the data can be uploaded directly from the Raspberry Pi 4B if internet connectivity is available for growers with Wi-Fi access. Secondly, the Raspberry Pi 4B transmits the recently acquired data to the Arduino MKR1300/1310. The Arduino MKR1300/1310 decodes the data received from the Raspberry Pi 4B and forwards it to the ThingSpeak. The second method is for low-rate, long-range communication beyond the limit of Wi-Fi. The long-range communication can be, e.g. a typical range of more than 300 m, which is beyond the typical Wi-Fi range.

A single message receivable to the ThingSpeak server includes data for eight fields. In our demonstration, a single message was enough to transmit the data generated. Fields 1 and 2 are reserved for the latitude and longitude to represent the device's location. The third field was for camera orientation. Image quality/crop type, plant count, weed count, insect count, and crop canopy coverage were allocated from fields four to eight. The ThingSpeak support eight channels per gateway. If additional data is generated in the future, we have to create new channels to accommodate them. However, only data in a single channel can be passed through a single message. The Arduino-LoRa library was used to prepare the LoRa messages forward to the gateway (Mistry, 2016). The message generated from the Arduino MKR1300/1310 includes the device identification number and the data with the field number. Once the gateway receives this message, it adds the target client id (generated by ThingSpeak when defining a device), host address (mqtt://mqtt3.thingspeak.com), server port number, username, and password, channel id, and the data in each field according to the Message Queuing Telemetry Transport (MQTT) protocol. Username and password ensure that only authorized devices can transmit data to the ThingSpeak platform.

ThingSpeak provides two ways to interact with its platform, and those protocols are REST and MQTT protocols. The advantages of using MQTT over representative state transfer (REST) protocol that support ThingSpeak data publishing, including immediate and minimum power consumption and data transmission over limited bandwidth, encourage us to select the MQTT protocol in our demonstration.

### EXPERIMENTAL RESULTS

### DCNN Model Performance.

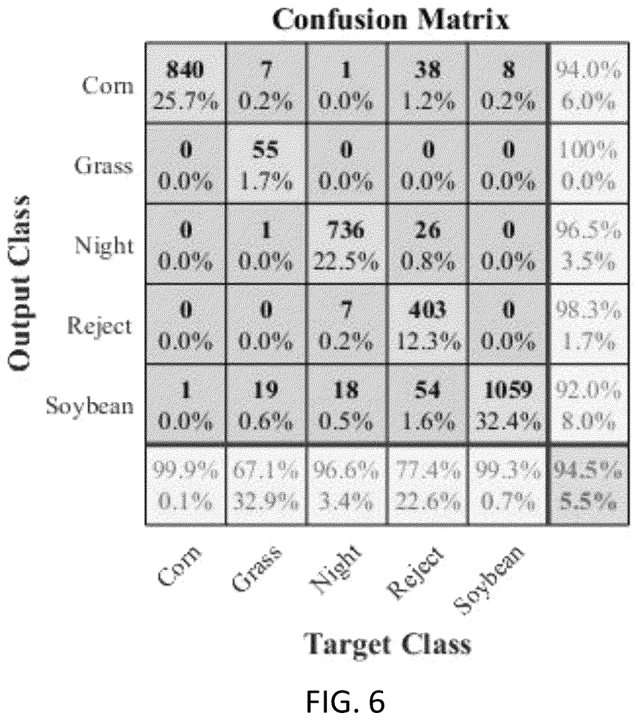

FIG. 6 shows a Confusion matrix for test images by CropClassiNet. CropClassiNet had a test accuracy of 91.26%, a Jaccard Index of 0.77, and an F1-score of 0.91; The highest precision is for the “grass” class (100%), and the lowest is for “soybean” (92.0%). The highest recall is for the “corn” class (99.9%), and the lowest is for “grass” (67.1%). The primary goal of CropClassiNet is to determine the quality of new images and direct them for subsequent processing. To the knowledge of the inventors, this step has never been executed in an image-based crop monitoring platform. Further, CropClassiNet can eliminate erroneous images when humans are present in the camera's field of view or when the camera is misaligned due to external factors. AlCropCAM can send maintenance requests through IoT analytics if rejected images are continuously generated.

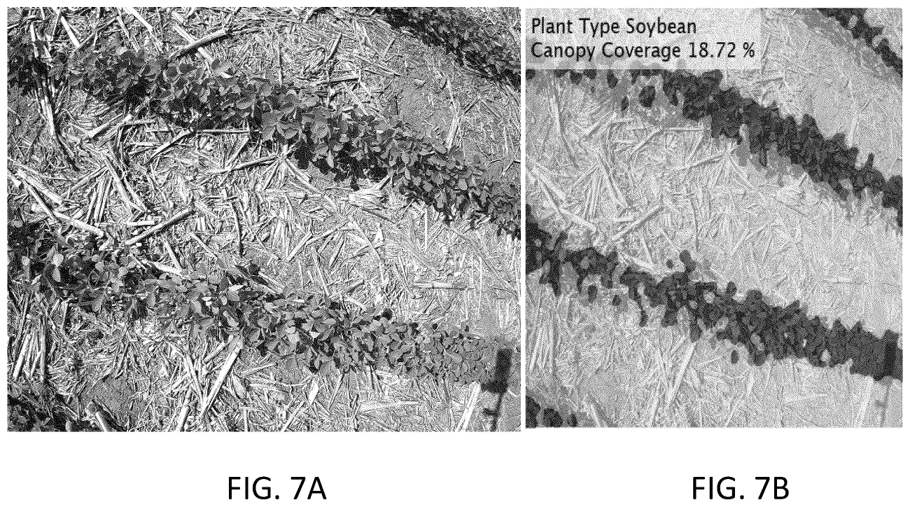

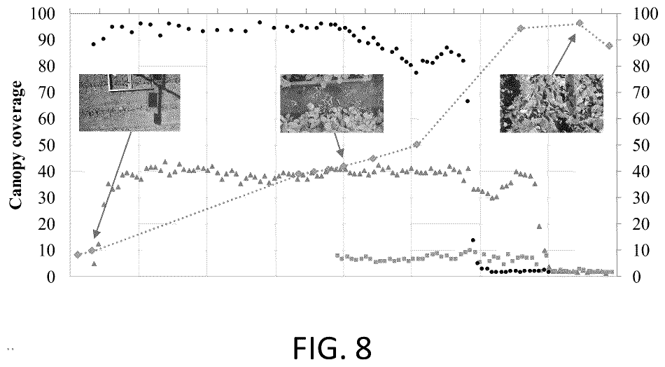

CanopySegNet on the test images achieved a global accuracy of 0.93, weighted IoU of 0.87, and mean BF score of 0.73. FIGS. 7A and 7B respectively show an example of an original soybean image and the segmentation result by CanopySegNet, with a CC estimate of 18.72%. Season-long, time-series images can be fed into CanopySegNet to generate diurnal and seasonal curves of crop CC, as shown in FIG. 8.

PlantCountNet and InsectNet are object detection and localization
models, their results are summarized in Table 5.

| | | | | Mean | |
|---|---|---|---|---|---|
| | | | Validation | average | Object |
| Model Name | Architecture | Input size | RMSE/FVL | precision | class |
| PlantCountNet | YOLOv2 | 320 × 320 × 3 | 0.888 (RMSE) | 0.66 | Soybean |
| | | | | 0.86 | Weed |
| InsectNet | YOLOv4 | 320 × 320 × 3 | 26.2 (FVL) | 0.02 | Insect |

Testing showed that PlantCountNet model outputs matched the labels of soybean and weed plants well, as well as for plant and weed counting indicating high accuracy. InsectNet provided less accurate results. This can be addressed by increasing the resolution of the region of interest by splitting the original image while keeping the resolution the same. It allows insect detection with the same hardware without requesting upgraded hardware.

### Power Consumption for Raspberry Pi 4B

Experimental edge camera devices of the invention that include an RGB camera, single board computer (RaspberryPI), power supply, and the wireless communication integration can be implemented in farmlands with limited access to electric power, and information on their power consumption can be used to design IoT devices and systems consistent with the invention. AlCropCAM is designed to monitor field crops with a solar power supply. It runs on a rechargeable battery when there is no solar power. We monitored the maximum energy consumption of each task performed by AlCropCAM, and the result is presented in Table 6. Four main strategies are available for power management of IoT edge devices: Selecting power-efficient hardware, maintaining low power modes, dynamic power management, and cloud-based management. Raspberry Pi 4B was an affordable power-efficient single-board computer compatible with our application, but it does not naturally support low-power modes. Therefore, we introduced the Arduino MKR1300/1310 LoRa module for the Raspberry Pi 4B dynamic power management. Furthermore, this Arduino module allows us to perform cloud-based central management independently.

TABLE 6
Electrical power consumption of the Raspberry Pi model 4B
and the Arduino MKR 1300/1310 during edge image processing.

| | | The maximum current range |
|---|---|---|
| Device | Activity | and the voltage recorded |
| Raspberry | Idle run | 5.25 v × (0.45-0.53) A |
| Pi 4B | Image classification | 5.25 v × (0.97-1.04) A |
| | Image segmentation | 5.25 v × (0.98-1.11) A |
| | Weed and Plant Detection | 5.25 v × (0.62-0.70) A |
| | Insect detection | 5.25 v × (0.62-0.70) A |
| Arduino | Sleep mode | <0.01 A |
| MKR | Serial communication | <0.01 A |
| | LoRa Transmission | <0.01 A |

The experiments used a Raspberry Pi 4B with 8 GB of RAM, connected to an HDMI monitor, USB keyboard, and USB mouse, and ran a MathWorks® Raspbian image (file used to boot the Raspberry Pi 4B). The Raspberry Pi 4B was operated at room temperature and connected to a wireless LAN access point and a laptop via an Ethernet cable. The electric current consumption for running each DCNN model was recorded during the test. CropClassiNet had the highest current consumption, while the PlantCountNet and InsectNet models had the lowest. As for LoRa transmission, we could not measure its current consumption because the lowest value our instrument could measure was 0.01 A. Based on the manufacturer's specifications, the Arduino MKR1310 consumes 104 uA at 5V.

The average time to run the DCNN models is essential to estimate the energy consumed for each prediction. These parameters provide essential guidelines for designing IoT sensor nodes with suitable batteries and power sources. We also noticed that typically the first prediction of a model took the longest time, but the rest take a considerably shorter time to predict.

TABLE 7
Time duration needed for the selected DCNN
models deployed in the Raspberry Pi 4B.

| | | Time for | The maximum |
|---|---|---|---|
| | Input image Size | predicting | power demand |
| | (width × height) | results | for the activity |
| Model/Task | in pixels | (Seconds) | (voltage x current) |
| CropClassiNet/Image quality | 224 × 224 × 3 | 6.44 | 5.46 |
| evaluation and crop classification | | | |
| CanopySegNet/Semantic | 512 × 512 × 3 | 20.20 | 5.83 |
| segmentation to separate canopy | | | |
| from background | | | |
| PlantCountNet/Weed and plant | 320 × 320 × 3 | 14.38 | 3.68 |
| detection, classification, and | | | |
| counting | | | |
| InsectNet/Insect detection | 320 × 320 × 3 | 0.20 | 3.68 |

Semantic segmentation was the most power-demanding activity, while insect detection was the least. Changing the order of the image processing models and adding new models or dropping existing models is possible during regular operation. It enables dynamic power management within the Raspberry Pi module. The primary outcome of table 6 is that DC is directly proportional to power consumption.

AlCropCAM implements a stack of four DCNN-based image processing models with multiple objectives. Per our knowledge, this is the first time such a system was developed for a field crop monitoring camera. AlCropCAM has applications such as setting up smart in-field or greenhouse IoT camera networks with edge computing capability, monitoring crops by attaching them to pivot irrigation systems and collecting crop information through ground or aerial mobile robots. The relatively short time to run each DCNN model makes the system suitable for real-time applications, including variable rate irrigation, fertilization, and spraying. For example, a pivot irrigated multi-cropping system with AlCropCAM can automate irrigation or fertigation transition between different crops or crops at different growth stages by automatically providing the crop type or growth stage data to the irrigation controller. Additionally, existing weedicide or pesticide spraying applicators can get the feedback of the PlantCountNet and InsectNet in the AlCropCAM for precision spraying.

CropClassiNet can categorize captured images according to quality and detect the presence of specific crop types for further processing. CanopySegNet can further quantify the degree of canopy coverage; PlantCountNet can count the number of plants and weeds in the image; and finally, InsectNet can count the number of insects in the image.

Deep learning-based image processing on the edge has excellent potential in PA. Applications of AlCropCAM are not limited to image classification, segmentation, plant counting, or weed counting. Applications include insect classification and crop damage estimation, weed classification and pressure estimation, fruit identification and yield estimation, and disease identification and disease damage estimation in real time using actual field images.

AlCropCAM shows excellent potential in enhancing crop management through crop monitoring. Preferred embodiments use a camera on a moving platform like a pivot irrigator with a GPS receiver to generate spatiotemporal data with proximal remote sensing. Crop classification can include more crop types, and segmentation models need training data from other crop types. Weed and insect identification networks can have capability to identify different weed types, their growth stage, different insect types, and their growth stages to generate effective pest control decisions.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. An agriculture image analysis method, comprising:
acquiring crop canopy image data;
extracting multiple agricultural features from edge processing of the image data and conducting data reduction to produce a real-time transmissible data set using an automated phenocam that comprises a trained multiclass DCNN network; and
providing the real-time transmissible data to a cloud based resource.

2. The method of claim 1, wherein cloud based resource includes processing of the real-time transmissible data set to provide information to a user about the status of one or more of a crop, disease/pest pressure, pest type, number of emerged plants, and plant growth speed.

3. The method of claim 1, wherein the DCCN network comprises models for one or more of crop type classification, canopy cover quantification, plant and weed counting, and insect identification.

4. The method of claim 3, comprising running the models sequentially.

5. The method of claim 1, comprising classifying growth parameters of fractional canopy coverage, number of leaves, and percentage of successful plants.

6. The method of claim 1, in a system that includes a local processor that timestamps each image, wherein the DCNN includes a first classification model for image quality verification and a second model for crop feature analysis.

7. A system using the method of claim 1, comprising a components cluster mounted on a support in a field, the components cluster comprising imaging components mounted above the crop and RF components and antennas for communications.

8. The system of claim 7, comprising a soil moisture sensing data logger and an infrared radiometer data logger.

9. The system of claim 8, comprising a plurality of components clusters mounted on a plurality of supports, wherein the plurality of components clusters comprise processors and storage that implement the trained multiclass DCNN network.

10. The method of claim 1, wherein the DCNN network identifies a crop type and conducts canopy segmentation to reduce transmission data size.

11. The method of claim 10, wherein the DCNN network counts insects.

12. An automated phenocam, comprising:
imaging and crop sensors;
a local power source;
a single processor board that implements a trained multiclass DCNN network to produce a real-time transmissible data set regarding crop status.

13. The automated phenocam of claim 12, wherein the imaging and crop sensor include one or more of an Infrared radiometer, NDVI (normalized difference vegetation index) and PRI (photochemical reflectance index) sensors, a trail camera, and an imaging and multispectral sensing platform.
